(19) United States
(12) Patent Application Publication
(10) Pub. No.: US 2016/0034895 A1
(43) Pub. Date: Feb. 4, 2016

(54) PERSONALIZED BUDGETS FOR FINANCIAL SERVICES

(71) Applicant: INTERNATIONAL BUSINESS MACHINES CORPORATION, Armonk, NY (US)

(72) Inventors: Dianne Rodor Martini, Engenheiro Coelho (BR); Karina Ciotto Dos Santos, Valinhos (BR)

(21) Appl. No.: 14/882,555

(22) Filed: Oct. 14, 2015

Related U.S. Application Data
(62) Division of application No. 14/083,506, filed on Nov. 19, 2013.

(30) Foreign Application Priority Data
Nov. 23, 2012 (CA) 2796506

(51) Int. Cl. G06Q 20/40

(52) U.S. Cl. CPC G06Q 20/405

(57) ABSTRACT

An illustrative embodiment of a computer-implemented process for personalized financial budget tracking receives a request for a user purchase transaction, wherein the user purchase transaction is one of a purchase transaction and a payment transaction and responsive to a determination of a payment method, determines whether the user purchase transaction is authorized. Responsive to a determination the user purchase transaction is authorized, the computer-implemented process determines whether personalized expense categories are activated and responsive to a determination the personalized expense categories are activated, prompts for a category code. Responsive to receiving the category code, the computer-implemented process tracks expenses using a personalization category code received, wherein the personalization category code received is associated with the user purchase transaction.

### BACKGROUND

1. Technical Field

This disclosure relates generally to financial services management using a data processing system and more specifically to personalized financial budget tracking for financial transactions using the data processing system.

2. Description of the Related Art

Keeping track of a budget is typically a difficult and time-consuming task. Once a budget has been planned and implemented reconciliation of expenses is left as a final phase.

A common practice involves a periodic review of expenses well after a purchase transaction has been made to reconcile payments with a purchase. Typically by the time an item is reviewed there is no documentation regarding the purpose of the expense or who made the purchase. In addition the impact of the expense on the planned budget has already occurred as have other expenses leaving management of the budget as an after the fact issue.

Financial services organizations, for example banks and credit card issuing enterprises, offer a service to allocate expenses resulting from transactions through a bank account or credit card in a set of predefined categories. The predefined categories are determined and managed by the organization owning the financial service.

Personal budget management systems exist for use by consumers, however a typical system enables a person to import a bank statement, but the person has to manually update reasons why funds were spent. The process is not automatic.

In another example, a financial institution categorizes the expense automatically, but the financial institution does not allow personalization and real time categorizing. The process of the example is only applicable for credit card expenses. In a similar example, a hand held electronic device enables a user to track expenses in real time, but the information is provided manually and is not associated with a banking or credit card institution.

Another example uses similar terminology, however the implementation provides a mechanism to track, and control and limit credit card expenses for a participating company. As in the previous example, the current example does not allow personalized categorization, and applies only to credit card expenses.

In yet another example, a system automatically tracks checking account transactions using icons representative of expenses. The bank predetermines the icons, which are on the preprinted blank check. An icon associated with an item expense is selected by the customer when the check is completed; the paying bank scans the icon during check processing, and periodically sends the customer a statement including expenses categorized according to the predetermined and selected icon associated with a processed check.

### SUMMARY

According to one embodiment, a computer-implemented process for personalized financial budget tracking receives a request for a user purchase transaction, wherein the user purchase transaction is one of a purchase transaction and a payment transaction and responsive to a determination of a payment method, determines whether the user purchase transaction is authorized. Responsive to a determination the user purchase transaction is authorized, the computer-implemented process determines whether personalized expense categories are activated and responsive to a determination the personalized expense categories are activated, prompts for a category code. Responsive to receiving the category code, the computer-implemented process tracks expenses using a personalization category code received, wherein the personalization category code received is associated with the user purchase transaction.

According to another embodiment, a computer program product for personalized financial budget tracking comprises a computer recordable-type data storage media containing computer executable program code stored thereon. The computer executable program code comprises computer executable program code for receiving a request for a user purchase transaction, wherein the user purchase transaction is one of a purchase transaction and a payment transaction; computer executable program code for determining a payment method used for the request; computer executable program code responsive to determining a payment method, for determining whether the user purchase transaction is authorized; computer executable program code responsive to a determination the user purchase transaction is authorized for determining whether personalized expense categories are activated; computer executable program code responsive to a determination the personalized expense categories are activated, for prompting for a category code and computer executable program code responsive to receiving the category code, tracking expenses using a personalization category code received, wherein the personalization category code received is associated with the user purchase transaction.

According to another embodiment, an apparatus for personalized financial budget tracking comprises a communications fabric, a memory connected to the communications fabric, wherein the memory contains computer executable program code, a communications unit connected to the communications fabric, an input/output unit connected to the communications fabric, a display connected to the communications fabric and a processor unit connected to the communications fabric. The processor unit executes the computer executable program code to direct the apparatus to receive a request for a user purchase transaction, wherein the user purchase transaction is one of a purchase transaction and a payment transaction; determine a payment method used for the request; responsive to determining a payment method, determine whether the user purchase transaction is authorized; responsive to a determination the user purchase transaction is authorized, determine whether personalized expense categories are activated; responsive to a determination the personalized expense categories are activated; prompt for a category code and responsive to receiving the category code, tracking expenses using a personalization category code, wherein the personalization category code received is associated with the user purchase transaction.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a block diagram of an exemplary network data processing system operable for various embodiments of the disclosure;

FIG. 2 is a block diagram of an exemplary data processing system operable for various embodiments of the disclosure;

FIG. 3 is a block diagram of a personal finance categorization system operable for various embodiments of the disclosure;

FIG. 4 is a flowchart of a process for defining a set of personal finance categories operable for various embodiments of the disclosure;

FIG. 5 is a flowchart of a process for assigning a budget to a category in a set of personal finance categories operable for various embodiments of the disclosure; and

FIG. 6 is a flowchart of a process using a set of personal finance categories operable for various embodiments of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer-readable data storage medium(s) may be utilized. A computer-readable data storage medium may be, for example, but not limited to, an electronic, magnetic, optical, or semiconductor system, apparatus, or device, or any suitable combination of the foregoing. More specific examples (a non-exhaustive list) of the computer-readable data storage medium would include the following: a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device or any suitable combination of the foregoing. In the context of this document, a computer-readable data storage medium may be any tangible medium that can contain, or store a program for use by or in connection with an instruction execution system, apparatus, or device.

A computer-readable signal medium may include a propagated data signal with the computer-readable program code embodied therein, for example, either in baseband or as part of a carrier wave. Such a propagated signal may take a variety of forms, including but not limited to electro-magnetic, optical or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer-readable medium may be transmitted using any appropriate medium, including but not limited to wireless, wire line, optical fiber cable, RF, etc. or any suitable combination of the foregoing.

Computer program code for carrying out operations for aspects of the present disclosure may be written in any combination of one or more programming languages, including an object oriented programming language such as Java®, Smalltalk, C++, or the like and conventional procedural programming languages, such as the “C” programming language or similar programming languages. Java and all Java-based trademarks and logos are trademarks of Oracle, and/or its affiliates, in the United States, other countries or both. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus, (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

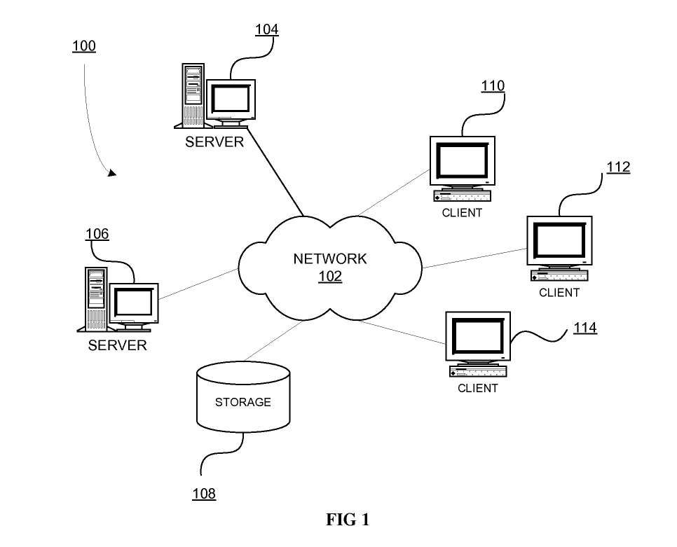

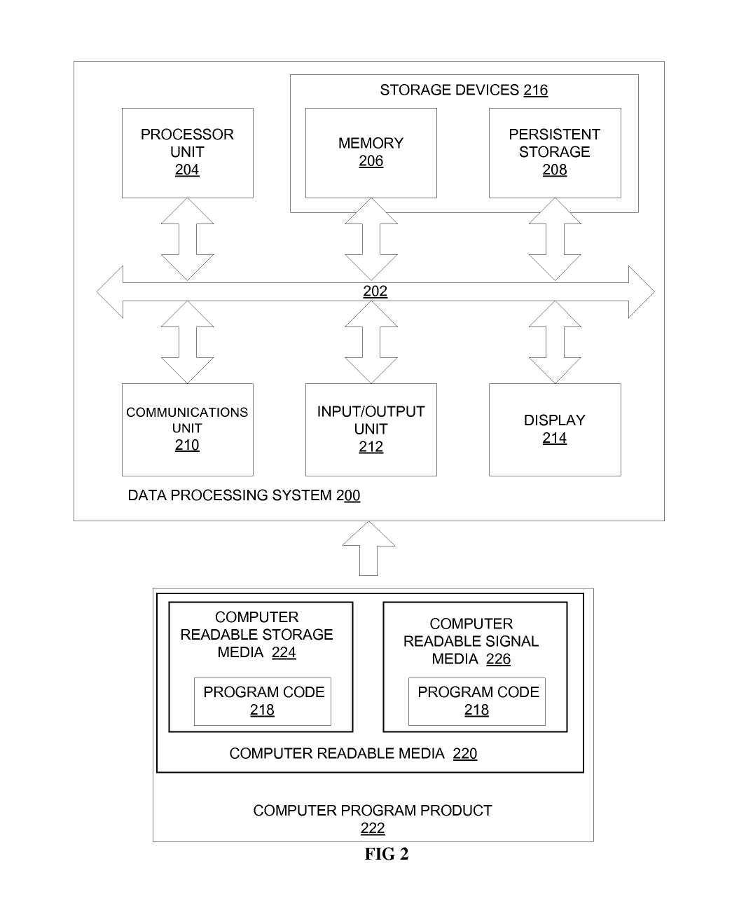

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

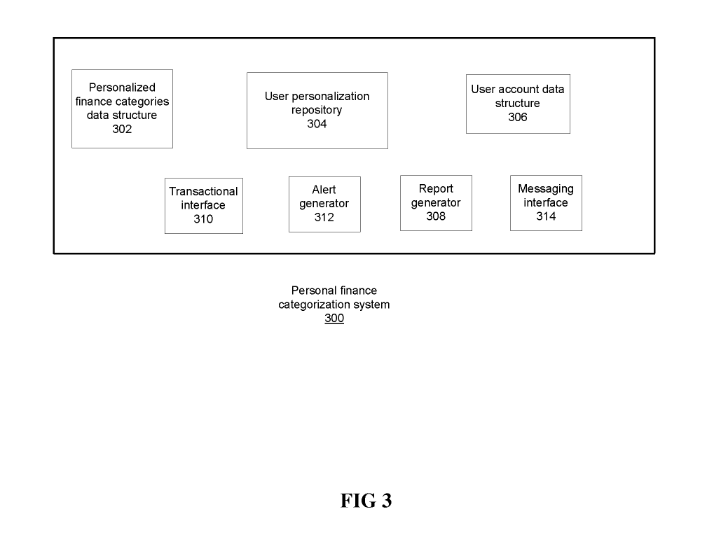

FIG. 1 depicts a pictorial representation of a network of data processing systems in which illustrative embodiments may be implemented. Network data processing system 100 is a network of computers in which the illustrative embodiments may be implemented. For example, network data processing system 100 may be representative of a banking system in which personal finance categorization system 300 of FIG. 3 is implemented on a server such as server 104 in communication with a customer on client 110 performing an online purchase transaction or in which client 112 represents a point of sale terminal for performing a purchase transaction.

Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference to FIG. 2 a block diagram of an exemplary data processing system operable for various embodiments of the disclosure is presented. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples the instructions are in a functional form on persistent storage 208. These instructions may be loaded into memory 206 for execution by processor unit 204. The processes of the different embodiments may be performed by processor unit 204 using computer-implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable storage media, such as memory 206 or persistent storage 208.

Program code 218 is located in a functional form on computer readable storage media 220 that is selectively removable and may be loaded onto or transferred to data processing system 200 for execution by processor unit 204. Program code 218 and computer readable storage media 220 form computer program product 222 in these examples. In one example, computer readable storage media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable storage media 220 also may take the form of a persistent storage, such as a hard drive, a thumb drive, or a flash memory that is connected to data processing system 200. The tangible form of computer readable storage media 220 is also referred to as computer recordable storage media. In some instances, computer readable storage media 220 may not be removable.

Alternatively, program code 218 may be transferred to data processing system 200 from computer readable storage media 220 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

Using data processing system 200 of FIG. 2 as an example, a computer-implemented process for personalized financial budget tracking is presented. Processor unit 204 receives a request for a user purchase transaction, wherein the user purchase transaction is one of a purchase transaction and a payment transaction and responsive to a determination of a payment method, determines whether the user purchase transaction is authorized. Responsive to a determination the user purchase transaction is authorized, processor unit 204 determines whether personalized expense categories are activated and responsive to a determination the personalized expense categories are activated, prompts for a category code. Responsive to receiving the category code, processor unit 204 tracks expenses using a personalization category code received, wherein the personalization category code received is associated with the user purchase transaction.

An embodiment of the disclosed process provides a capability for a financial service such as a bank to provide a personalized budget service for a client, enabling the client to identify purchases classified in categories defined by the client, as previously personalized by the card owner client, wherein the card represents a bank card or credit card available for use by the client. The defined categories are enabled for use with bank credit cards, debit cards, cash withdrawals and Internet banking transactions processed though an enabled account management system.

With reference to FIG. 3 a block diagram of a personal finance categorization system operable for various embodiments of the disclosure is presented. Personal finance categorization system 300 is an example of a system for providing a capability of personal finance categorization supporting customer selected or defined categories for capturing expense information associated with a purchase or payment of a financial transaction.

Personal finance categorization system 300 includes a number of components including personalized finance categories data structure 302, user personalization repository 304, user account data structure 306, report generator 308, transaction interface 310, alert generator 312, and messaging interface 314. Personal finance categorization system 300 leverages an underlying data processing system for example, server 106 of network data processing system 100 of FIG. 1 or data processing system 200 of FIG. 2 in support the operational capabilities of the personal finance categorization system.

An embodiment of personal finance categorization system 300 may be implemented in alternative embodiments as a number of discrete components, a collection of logical components or a monolithic component without loss of function or capability.

Using an embodiment of the disclosed process an Internet service such as online banking provided by a banking enterprise enables a customer to create personalized expense categories that reflect the personal expenses of the respective customer. For example, a customer may choose to identify categories for which expenses are to be identified and tracked comprising rent, utilities, food, clothes, and miscellaneous categories maintained as a set of attributes with associated values in personalized finance categories data structure 302. Personalized finance categories data structure 302 may also be combined with user account data structure 306 enabling reporting of account activity in association with the categories identified with an account holder.

Personalized finance categories data structure 302 provides a capability to collect the personalized finance category in a data structure for ease of access, reference and maintenance. Data storage for personalized finance categories data structure 302 is provided in typical file system or data base management provided technology.

The personalized finance categories comprise a set of categories as determined by the user (customer) to be relevant and includes a set of predefined finance categories which may be provided in addition to user-defined categories or replaced by the user-defined categories.

User personalization repository 304 provides a capability for storing, updating and retrieving the settings applied resulting from definitions in personalized finance categories data structure 302 for a plurality of users supported by the financial service organization. An embodiment may associate the information contained within with user account data structure 306 or in alternative may combine the information with personalized finance categories data structure 302 as well as user account data structure 306. A combination can be formed in a physical or a logical relation.

User account data structure 306 is a data structure maintained by the financial service organization, for example a bank or credit card issuing enterprise. (herein the term bank, credit card issuing enterprise, and financial service organization may be used interchangeably) The account information represents typical personal identification information as well financial information associated with the account holder including payroll or income information and account limits or restrictions with regard to financial transaction such as withdrawal amounts, purchase amounts or borrowing criteria. Real time or otherwise periodic updates of a user account status is maintained using user account data structure 306.

Report generator 308 provides a capability to create summarized information representative of account holder activity, for example, financial transaction information associated with a respective account. In a simple form, a report is created typical of a bank statement. Using an embodiment of the disclosed process, wherein a user is registered to use personalized finance categories and therefore has personalized finance categories defined for the respective user, the report includes information representative of expenditures in each respective category.

A report may be accessed periodically, for example a monthly statement whether a paper copy mailed to the user or accessible through online services. A report may also be a subset of information, for example, a selection of personalized finance category information.

Transaction interface 310 provides a capability to interact with commercial entities offering financial services including purchase and payment transactions. The interface enables the sending to and receiving from information for the financial services organization with which the user has registered to use personalized finance categories. For example, transaction interface 310 provides a capability of prompting a user during a point of sale session for information and receiving user input during the same session. The transaction interface may be a simple extension to an existing payment authorization and capture system already in place.

Alert generator 312 provides a capability for determining whether a predefined condition or event has occurred with regard to a user, a financial transaction and a user account. For example, a user may have defined a personalized finance category with an associated expenditure threshold. For example, the expenditure threshold may be a predetermined individual amount or an accumulated total per defined time period for a particular personalized finance category or a combination of personalized finance categories. In another example, an alert may be raised when insufficient funds are available.

Messaging interface 314 provides a capability for communicating an alert to a respective user during or after a financial transaction session. For example, a definition may require the sending of a specific alert or a type of alert in real time using a preferred communication path, such as a text message to a cell phone. In another example, wherein real time information is not desired an email notice confirming a purchase within a specific personalized finance category or a combination of personalized finance categories is sufficient.

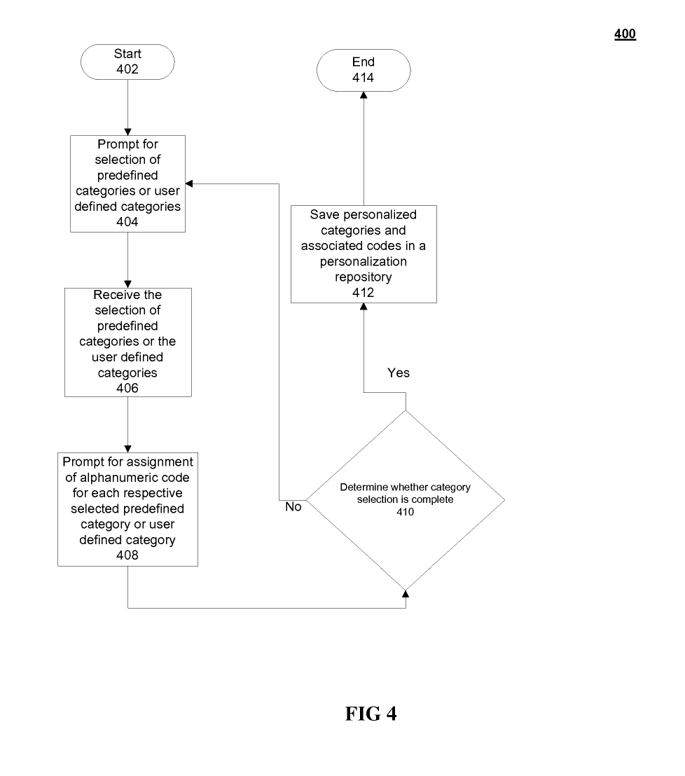

With reference to FIG. 4 a flowchart of a process for defining a set of personal finance categories operable for various embodiments of the disclosure is presented. Process 400 is an example using personal finance categorization system 300 of FIG. 3 for providing a set of personal finance categories supporting customer selected or defined categories for capturing expense information associated with a purchase or payment of a financial transaction.

Process 400 starts (step 402) and prompts a user for a selection of predefined categories or to provide user defined categories (step 404). The predefined categories are offered by the financial services organization providing the purchase and payment tracking service. An initial set of predefined categories is offered as a seed set to aid the user and is not intended to be the only categories used. However a user may decide to select only those categories offered in the predefined set of categories when the offer is complete and relevant to the user.

User defined categories enable the user to provide meaningful names and granularity as determined to suit the specific respective user. For example, rather than a category default label of rent, a user may determine a more suitable term is house rental A and additional apartment rental B to distinguish rental properties.

In addition a user-defined category may be a related sub-set of a parent category. For example using the rent default, a sub-set category for each of house rental A and additional apartment rental B may be useful to track individual expenditures but enable easy summation. In another example, a clothing category can be further defined to enable a sub-set for a particular child.

Process 400 receives the selection of the predefined categories and/or the user defined categories (step 406). As previously stated the predefined categories may be used as provide, may be replaced by the user-defined categories or may be used in combination with the user-defined categories as determined by a user.

Process 400 prompts for assignment of an alphanumeric code for each respective selected predefined category and/or the user defined category (step 408). In a typical implementation of an embodiment of the disclosed process a code would be limited to four characters. Too many characters may lead to errors in entering or remembering the code values, but a limitation is determined by an implementation. Selecting categories, defining categories and assigning code values may be combined in a sequence of iterative operatives depending upon an implementation and user interface capability. A personalization category code (or simply referred to as a category code) is assigned to each category (or sub-category as needed) and later associated with a user purchase transaction.

A determination is made whether category selection is complete (step 410). Responsive to a determination that category selection is not complete, process 400 returns to perform step 404 as before. Responsive to a determination that category selection is complete, process 400 saves the personalized categories and associated codes in a personalization repository (step 412) and terminates thereafter (step 414).

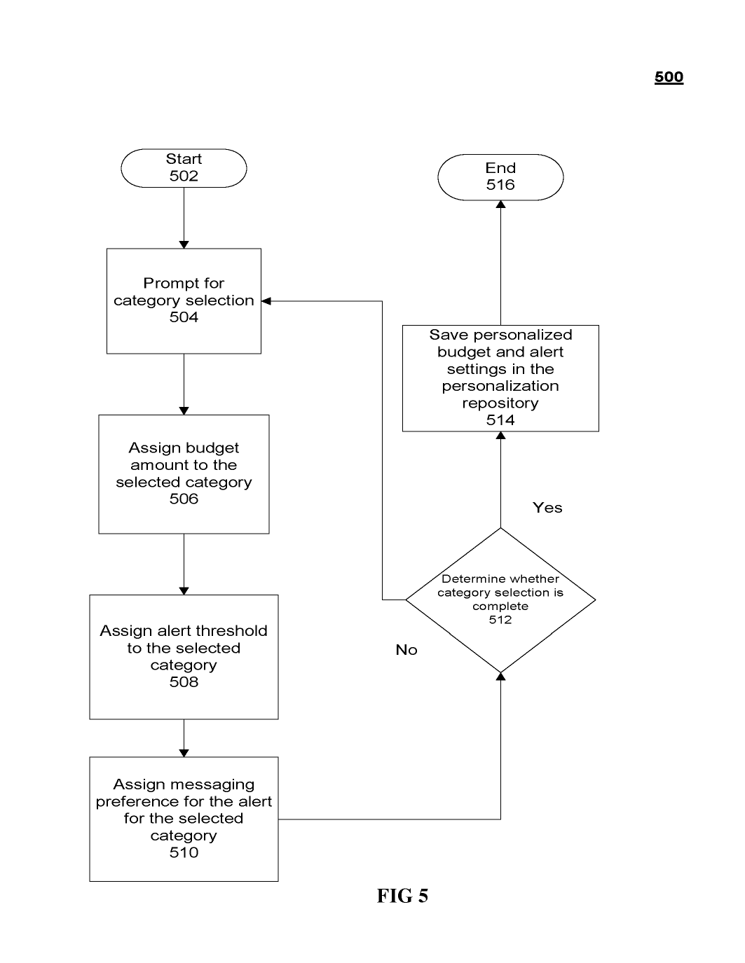

With reference to FIG. 5 a flowchart of a process for assigning a budget to a category in a set of personal finance categories operable for various embodiments of the disclosure is presented. Process 500 is an example assigning a budget, during setup, to a category within a defined set of personal finance categories using personal finance categorization system 300 of FIG. 3 providing a set of personal finance categories supporting customer selected or defined categories for notifying a user of expense information associated with a purchase or payment of a financial transaction.

Process 500 starts (step 502) and prompts a user for a category selection (step 504). Process 500 prompts the user to assign a budget amount to the selected category (step 506). Process 500 prompts the user to assign an alert threshold to the selected category (step 508).

Process 500 prompts a user to assign a messaging preference for the alert for the selected category (step 504). As indicated previously the messaging preference provides a capability to define how an alert occurrence is communicated to a respective user. The messaging preference specifies which type of alert is matched with which type of message communication to enable alerts deemed to be important to be communicated actively (for example, automated phone call), other alerts are communicated less actively (for example, text message) while other alerts deemed to be less important are communicated passively (for example, email).

The sequence of operations can be replaced in an alternative embodiment with a user interface dialog enabling multiple input fields to be completed at once thereby reducing the iterations between the user and the system as determined by an implementation. The actions presented in process 500 disclose one example of an information capture technique.

Process 500 determines whether category selection is complete (step 512). Responsive to a determination that category selection is not complete, process 500 returns to perform step 504 as before. Responsive to a determination that category selection is complete, process 500 saves the personalized budget and alert settings in a personalization repository (step 514) and terminates thereafter (step 516).

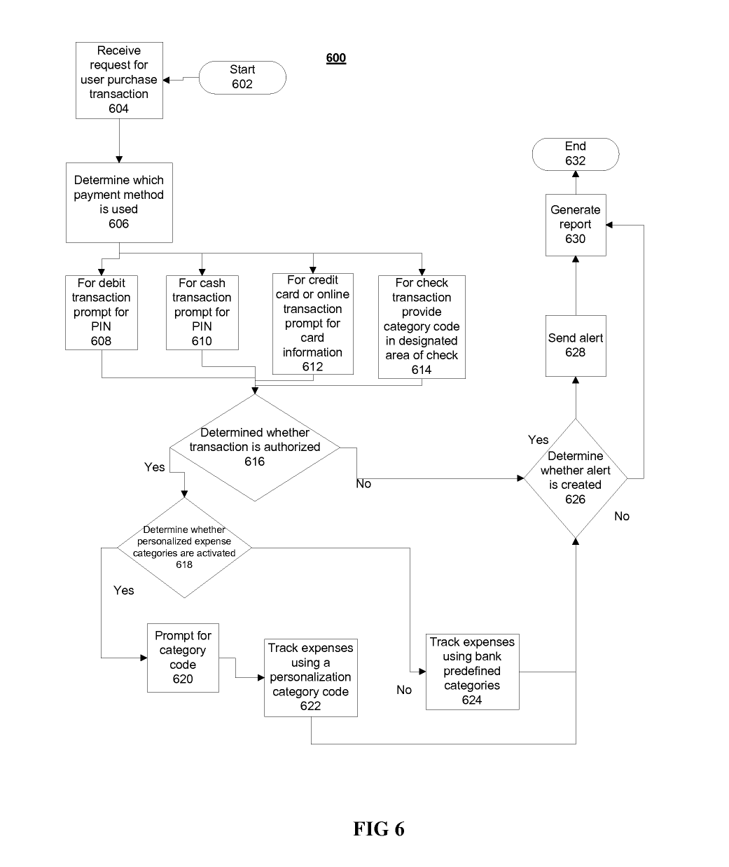

With reference to FIG. 6 a flowchart of a process using a set of personal finance categories operable for various embodiments of the disclosure is presented. Process 600 is an example of using personal finance categorization system 300 of FIG. 3 providing a set of personal finance categories supporting customer selected or defined categories for notifying a user of expense information associated with a purchase or payment of a financial transaction.

Process 600 begins (step 602) and receives a request for a user purchase transaction (step 604). The user purchase transaction may alternatively be another financial transaction for example a payment transaction. Process 600 determines which payment method is used (step 606). A payment method may be determined using a card type or receiving input indicative of a payment method.

Responsive to a determination that the payment method is a debit card, the customer is prompted to provide a personal identification number (PIN) (step 608). Responsive to a determination that the payment method is a cash withdrawal at an automated teller machine (ATM) or bank, the customer is prompted to provide a personal identification number (PIN) (step 610). Responsive to a determination that the payment method is a bill payment or credit card transaction using an online banking service, the customer is prompted to provide card information (when not available using a card reader) (step 612). Responsive to a determination that the payment method is a check a field on the printed check is used to enable the category to be identified during the writing of a check (step 614).

Process 600 determines whether the transaction is authorized (step 616). Responsive to a determination that the transaction is not authorized, process 600 skips ahead to perform step 626. Responsive to a determination that the transaction is authorized, process 600 determines whether personalized expense categories are activated (step 618).

Responsive to a determination that personalized expense categories are activated, process 600 prompts for a category code (step 620). The category code is an alphanumeric code or number corresponding to a type of expense category previously defined and registered by the customer. A card management system using process 600 performs the prompt after receiving a personal identification number and authorization as is typically required for a card transaction. Process 600 enables tracking of expenses using personalization category codes (step 622). Responsive to a determination that personalized expense categories are not activated (or a code was not entered during the transaction), process 600 enables tracking of expenses using bank predefined category codes (step 624).

Process 600 determines whether an alert is created (step 626). An alert is created in accordance with the saved personalized budget and alert settings in the personalization repository. Responsive to a determination that an alert is created, process 600 send the alert (step 628). The alert is sent in accordance with a previously defined message procedure using the user defined alert settings saved in the personalization repository.

Responsive to a determination that an alert is not created, process skips step 628. Process 600 generates a report (step 630) and terminates thereafter (step 632). Upon completing a number of purchase transactions, the information associated with the transactions is processed by the bank and the customer receives a report in which the customer can view the expenses, using an online banking service, by category or receive a monthly bank statement showing the customer expense breakdown.

Using the categorizing feature of an embodiment of the disclosed process, the bank can add value to customers by providing a personalized budget system. For example, after a predefined period of time, the bank can generate a customer report showing a current spending trend of the respective customer including an amount of funds received, and an amount spent within each defined category. The report enables the customer to review current purchasing patterns. In addition the customer is provided an opportunity to input in the online banking system an ideal budget. The ideal budget typically includes a target amount to be saved, and target amounts to be spent within each category.

Having identified values for the ideal budget by the customer, the bank automatically separates an amount the customer wants to save and places the amount in a savings account. Whenever the customer is within a predetermined range of the ideal budget, the bank sends a message stating: You have an amount X left in your category 3 budget. The message may be an email notification, an automated telephone voice mail message or a special message system to a hand held device such as a cell phone or tablet type device.

The bank may or may not block the account of the customer when the customer exceeds the ideal budget target because the customer may have sufficient funds to draw from in another previously identified account or sub-account of the current account, however notification is provided in the form of an alert to the customer to provide awareness.

At any time the customer may use the online banking service to view a report to determine an account status, indicating funds remaining as well as funds saved. The user is enabled to alter a previously defined ideal budget to reflect new saving objectives, or to accommodate exceptional expenditures. Categories can be added or removed to reflect a change in needs.

Thus is presented in an illustrative embodiment a computer-implemented process for personalized financial budget tracking. The computer-implemented process receives a request for a user purchase transaction, wherein the user purchase transaction is one of a purchase transaction and a payment transaction and responsive to a determination of a payment method, determines whether the user purchase transaction is authorized. Responsive to a determination the user purchase transaction is authorized, the computer-implemented process determines whether personalized expense categories are activated and responsive to a determination the personalized expense categories are activated, prompts for a category code. Responsive to receiving the category code, the computer-implemented process tracks expenses using a personalization category code received, wherein the personalization category code received is associated with the user purchase transaction.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer readable data storage medium having computer executable instructions stored thereon in a variety of forms. Examples of computer readable data storage media include recordable-type media, such as a floppy disk, a hard disk drive, a RAM, CD-ROMs, DVD-ROMs. The computer executable instructions may take the form of coded formats that are decoded for actual use in a particular data processing system.

A data processing system suitable for storing and/or executing computer executable instructions comprising program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

What is claimed:

1. A computer program product for personalized financial budget tracking, the computer program product comprising:
a computer recordable-type media containing computer executable program code stored thereon, the computer executable program code comprising:
computer executable program code for receiving a request for a user purchase transaction, wherein the user purchase transaction is one of a purchase transaction and a payment transaction;
computer executable program code for determining a payment method used for the request;
computer executable program code responsive to determining a payment method, for determining whether the user purchase transaction is authorized;
computer executable program code responsive to a determination the user purchase transaction is authorized for determining whether personalized expense categories are activated;
computer executable program code responsive to a determination the personalized expense categories are activated, for prompting for a category code; and
computer executable program code responsive to receiving the category code, tracking expenses using a personalization category code received, wherein the personalization category code received is associated with the user purchase transaction.

2. The computer program product of claim 1 wherein computer executable program code responsive to a determination the user purchase transaction is not authorized, comprises computer executable program code for determining whether an alert is created, wherein the user purchase transaction comprises one of a debit transaction, a cash transaction, a credit transaction and a check transaction.

3. The computer program product of claim 1 wherein computer executable program code for tracking expenses using a personalization category code associated with the user purchase transaction further comprises: computer executable program code for receiving a personalization category code associated with the user purchase transaction, wherein the personalization category code is an alphanumeric code assigned by a user.

4. The computer program product of claim 1 further comprising:
computer executable program code for generating a report, wherein the report comprises at least one expense associated with a personalization category code associated with the user purchase transaction.

5. The computer program product of claim 1 wherein computer executable program code for tracking expenses using a personalization category code associated with the user purchase transaction further comprises: computer executable program code for determining whether an alert is created; and computer executable program code responsive to a determination the alert is created, for sending the alert to the user using alert settings associated with the user and saved in a personalization repository.

6. The computer program product of claim 1 wherein computer executable program code for determining whether the alert is created further comprises:
computer executable program code for assigning a budget amount to a category in a set of personalized expense categories;
computer executable program code for assigning an alert threshold to a selected category in the set of personalized expense categories;
computer executable program code for assigning a messaging preference for the alert for the selected category in the set of personalized expense categories; and
computer executable program code for determining whether expenditure exceeds the alert threshold for the budget amount assigned to the selected category in the set of personalized expense categories.

7. The computer program product of claim 1 further comprising: computer executable program code responsive to a determination the personalized expense categories are not activated, for tracking expenses using bank-predefined categories.

8. The computer program product of claim 1 wherein the computer recordable-type media containing computer executable program code stored thereon is executed on a computing system comprising: a communications fabric; a memory connected to the communications fabric, wherein the memory contains computer executable program code; a communications unit connected to the communications fabric; an input/output unit connected to the communications fabric; a display connected to the communications fabric; and a processor unit connected to the communications fabric, wherein the processor unit executes the computer executable program code to direct the computer-implemented process to perform the steps of claim 1.

9. The computer program product of claim 8, wherein the processor unit executes the computer executable program code to determine whether an alert is created further comprising: assign a budget amount to a category in a set of personalized expense categories; assign an alert threshold to a selected category in the set of personalized expense categories; assign a messaging preference for the alert for the selected category in the set of personalized expense categories; and determine whether expenditure exceeds the alert threshold for the budget amount assigned to the selected category in the set of personalized expense categories.
